(19) United States
(12) Patent Application Publication
(10) Pub. No.: US 2014/0246550 A1
(43) Pub. Date: Sep. 4, 2014

(54) Clamping device to hold containers and other objects to fixtures

(71) Applicants: Clifford Thier, Avon, CT (US); Denise Kafka, Avon, CT (US)

(72) Inventors: Clifford Thier, Avon, CT (US); Denise Kafka, Avon, CT (US)

(21) Appl. No.: 14/166,843

(22) Filed: Feb. 24, 2014

Related U.S. Application Data
(60) Provisional application No. 61/757,574, filed on Jan. 28, 2013.
(60) Provisional application No. 61/876,996, filed on Sep. 12, 2013.

(51) Int. Cl. F16M 13/02

(52) U.S. Cl. CPC F16M 13/022
USPC 248/226.11

(57) ABSTRACT

A device composed of two novel apparatuses to hold cups, containers, tools and other objects in a stable position alongside tables, airline trays, doors, boards or other structures (“fixture”) so that (1) the objects or their contents are prevented from falling over or spilling; (2) the fixture's usable surface area is increased; (3) the objects are kept proximate to their users; and (4) the objects (e.g., a flashlight) can be oriented for best use.

### REFERENCE TO RELATED APPLICATIONS

The application claims the benefit of the earlier filing date of co-pending U.S. Provisional Patent Application No. 61/757,574, filed Jan. 1, 2013 and incorporated herein by reference; and U.S. Provisional Patent Application No. 61/876,996, filed Sep. 12, 2013 and incorporated herein by reference.

### FIELD OF THE INVENTION

The present invention is a novel clamping device that may be integrated with a novel holding device that holds containers or tools or other objects. Other embodiments are also described and claimed.

### BACKGROUND OF THE INVENTION

It is commonplace that people have a need to attach objects (such as—but not limited to—tools or light sources) to a fixture (such as—but not limited to—a table, tray, wall, door) so that the objects are close at hand to their user, or are operational from the place where they are affixed.

It is also commonplace that people keep a beverage close at hand when they are working or relaxing. The beverage, when sitting on a fixture such as a table, tray, or desk, becomes a potential hazard because it can spill onto the individual, electronic devices, electronic tools, or documents. The outcome can be burns to the individual, damage to the devices, tools or documents, or destruction of the devices, tools or documents.

It is also commonplace that people have a need to maximize the available work space on a fixture such as a desk, table, or tray, so they would prefer to keep beverages or other items off the surface of the fixture but still close to hand.

### SUMMARY

One purpose of the present invention is to provide an improved clamp that will secure the invention and anything held by the invention to a fixture to prevent movement or separation.

Another purpose of the present invention is to provide an improved apparatus to hold objects (such as containers) so that the contents of such objects do not spill.

Another purpose is to remove objects from the top surface of a fixture so as to increase the fixture's usable surface area.

Another purpose is to provide for a way to hold a range of objects by substituting one type of holding structure for another (e.g., substituting a magnet for a ring).

The operation of the invention involves seven steps:
1) squeezing the trigger segment of the invention to separate the gripping arms and thereby open the clamp;
2) sliding the open clamp around the fixture;
3) releasing the trigger segment;
4) pulling out the spring-loaded holding device from its at-rest position;
5) turning the holding device to the desired horizontal position;
6) releasing the holding device so it again locks into place; and
7) placing an object into the holding apparatus (which in the described embodiment is an open ring, but may be an alternative shape or composition such as a hook or a magnet).

### BRIEF DESCRIPTION OF THE DRAWINGS

The following detailed description will be better understood when read in conjunction with the figures appended hereto. For the purpose of illustrating the invention, there is shown in the drawings a preferred embodiment. It is understood, however, that this invention is not limited to this embodiment or the precise arrangements shown.

The drawings show an embodiment made from a solid material. However, this invention can just as well be built from bent wire or smaller solid pieces with additional joints between the smaller pieces.

FIG. 1A shows the invention with the holding ring undeployed.

FIG. 1B shows the invention with the holding ring deployed.

FIG. 1C shows the invention with the holding ring deployed and the clamp open.

FIG. 1D shows the invention fully deployed, holding an object (in this drawing, a cup) while gripping a fixture (e.g., a table). It should be noted that this device is not limited to holding only containers, but can be configured to hold tools, electronic devices and other objects. Alternative specialized holding apparatuses that support such objects as flashlights or screwdrivers could be substituted for the ring shown in the drawings.

FIG. 2 shows each of the parts of the invention in an exploded view.

FIG. 3A shows a side view of z-shaped body 11 and its individual segments: upper clamping arm segment 11a; spine segment 11b; leg segment 11c; and mortise slot segment 11d. FIG. 3A also shows pad 12, an elastic material that attaches to the underside of the upper clamping arm segment 11a.

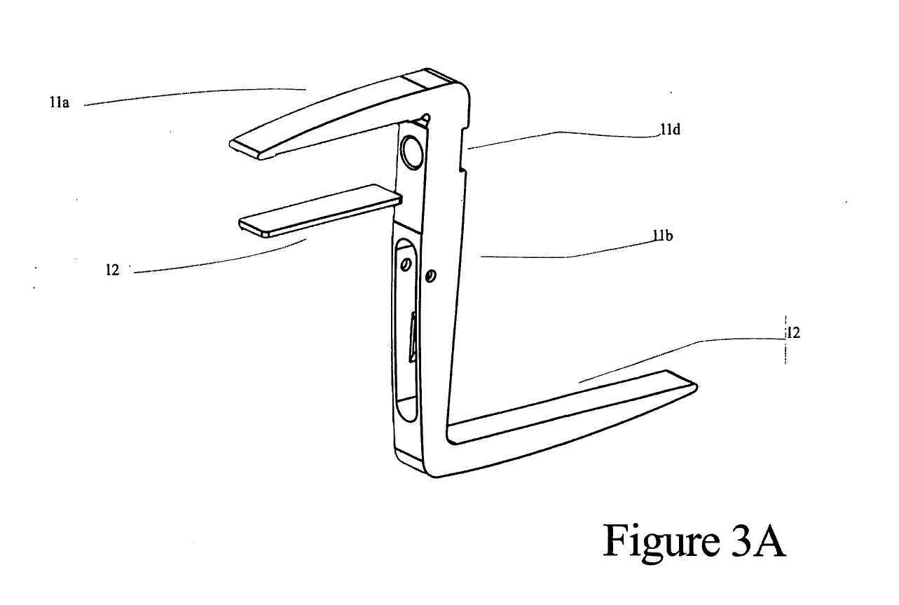

FIG. 3B shows a side view of lever 21 and labels its individual segments: lower clamping arm segment 21a; pivoting arm segment 21b; and trigger segment 21c. FIG. 3B also shows pad 24, an elastic material that attaches around lower clamping arm segment 21a.

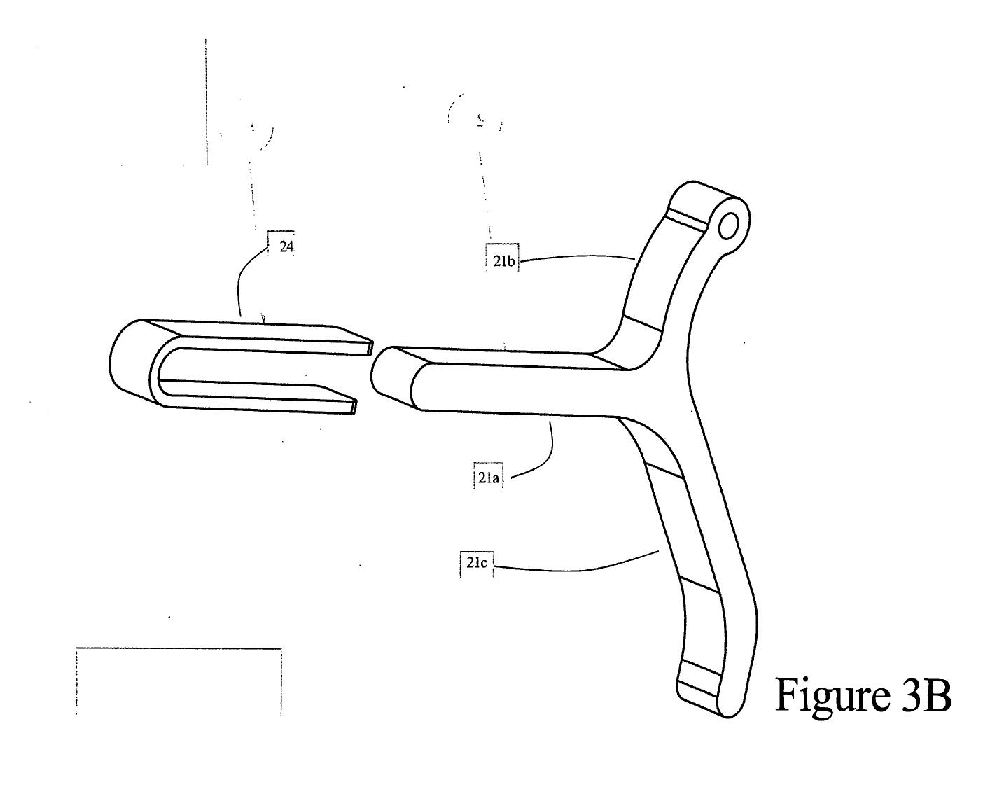

FIG. 3C shows an overhead view of Ring 31 and its cube-shaped tenon segment 31a.

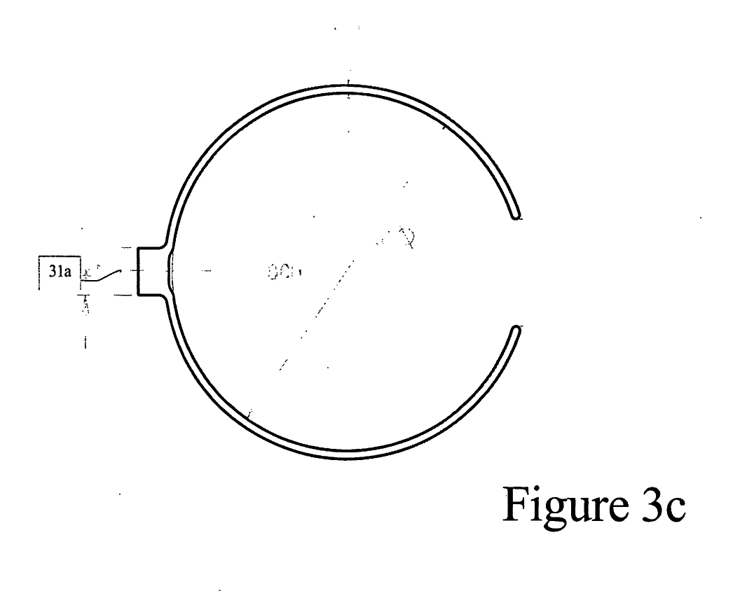

FIG. 4 shows the parts assembled and the invention holding an object (in this drawing a cup) inside ring 31.

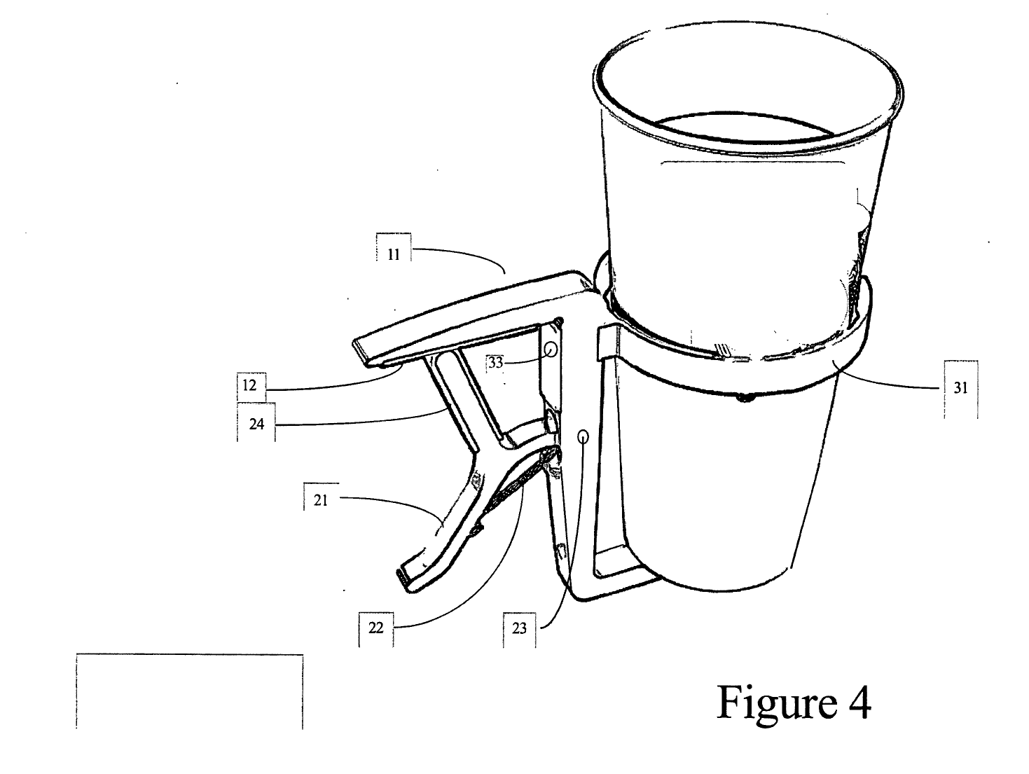

FIG. 5A shows the first step in utilizing the invention: applying force against trigger segment 21c in the direction shown, which pulls apart the upper and lower clamping arms.

FIG. 5B shows the second and third step in utilizing the invention: (1) sliding the open clamping arms around fixture; and (2) releasing the trigger segment.

FIG. 5C shows the fourth, fifth and sixth actions in utilizing the invention: (4) pulling out the ring 31; (5) rotating ring 31 ninety degrees; and (6) releasing ring into its desired position. The seventh step is to place the desired object into ring 31. It should be noted that the ring or a substitute holding device may be rotated more or less than ninety degrees depending on the object held and its particular function.

FIG. 6 shows the location and direction of the Clamping Forces (CFs), Contact Points (CPs), and Traverse Ejection Force (TEF) when a spring-style clamp is used.

FIG. 7 shows the location and direction of the CFs, CPs, and TEF when the invention's clamp apparatus is used.

### DESCRIPTION OF THE PARTS OF THE INVENTION

The clamping assembly of the invention consists of body 11 (with its upper clamping arm segment 11a) and lever 21. Lever 21 comprises a lower clamping arm 21a, a pivoting arm segment 21b, and a trigger segment 21c. The clamping assembly also includes spring 22 and pin 23, which hold lever 21 inside a slot in body 11.

The holding assembly of the invention consists of ring 31, which holds the cup or container and attaches to body 11. Cube-shaped tenon segment 31a sits inside square-shaped mortise segment 11d of body 11, and is held in place there by compression spring 32 and pin 33. Ring 31 can be rotated in body 11 or detached from body 11 for storage and/or transportation of the invention.

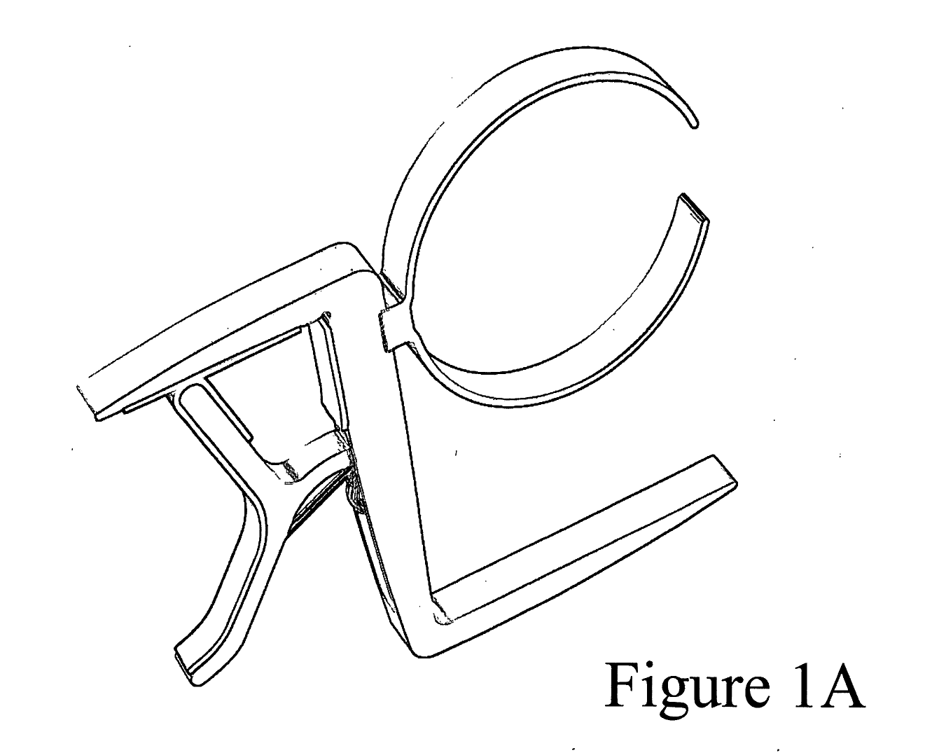

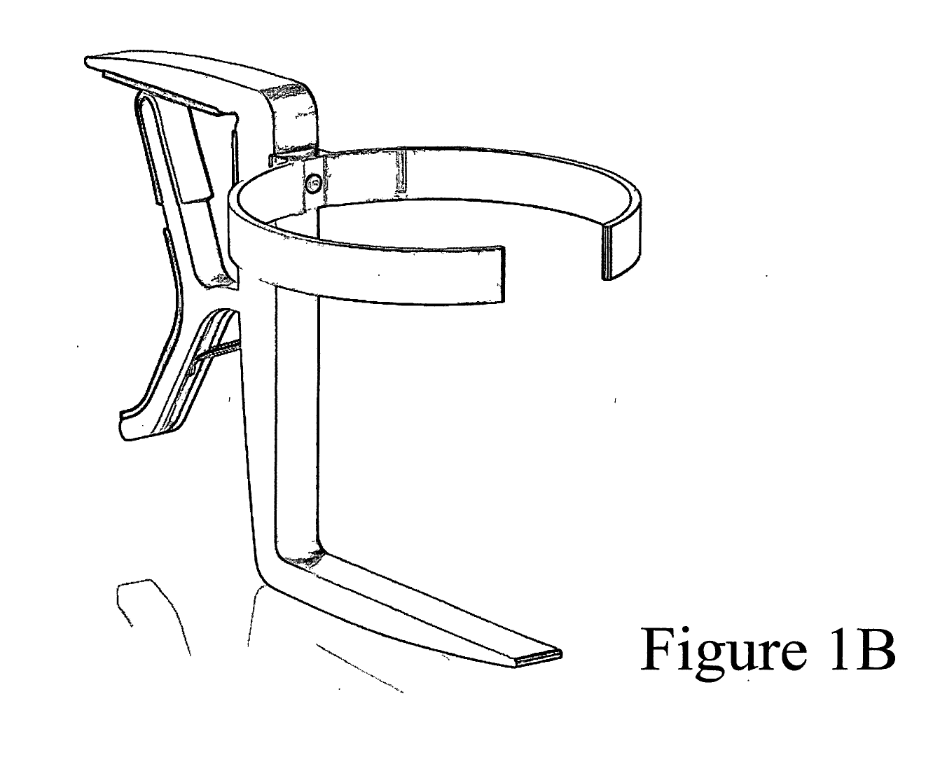

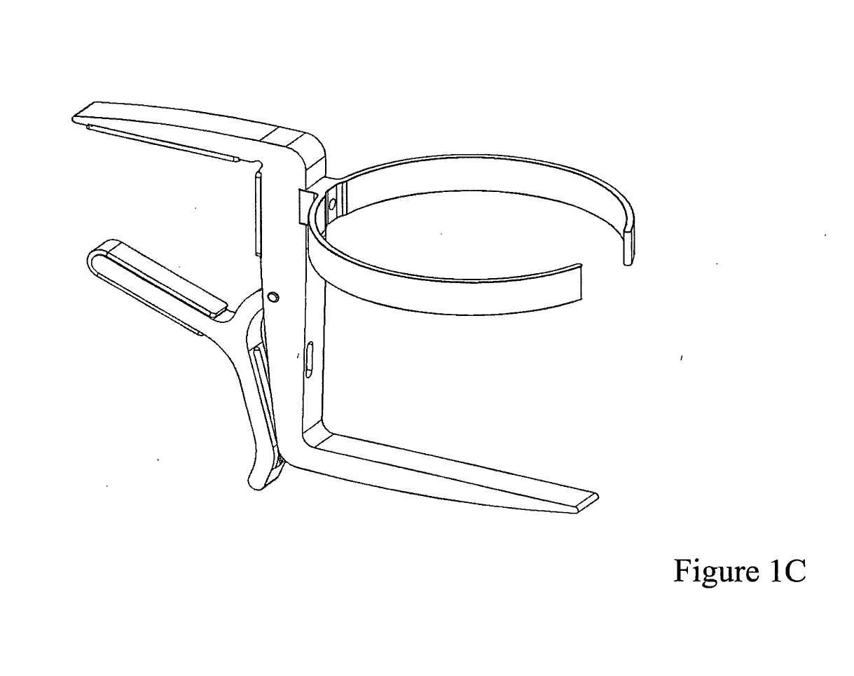

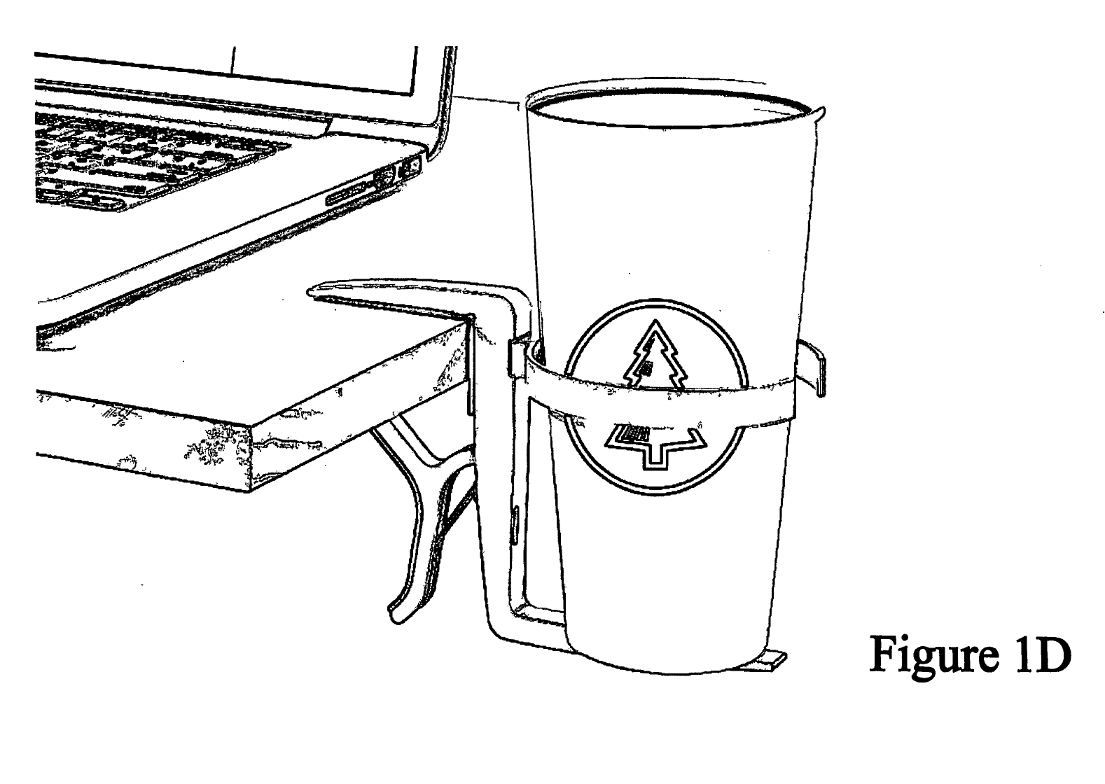

When the invention is not in use (FIG. 1A), ring 31 is in a vertical position that is parallel to the plane of the rest of the invention. When it is time to use the invention, ring 31 is pulled away from body 11, increasing the compression of spring 32 until the head on pin 33 prevents further pulling. Ring 31 is then rotated (typically 90 degrees) and released, with compression spring 32 pulling ring 31 back to body 11.

Instead of open ring 31, there may be an alternative specialized holding device—a different ring or a square, clip, clamp, or magnet—for holding objects such as tools or flashlights. Like open ring 31, the alternative device would be attached to spine segment 11b.

Leg segment 11c acts as a support for any object placed in ring 31. If the widest diameter of the object placed in ring 31 is larger than the inside diameter of the ring, it is possible that leg segment 11c will not be needed.

The diameter of ring 31 can vary from that showing in the drawings.

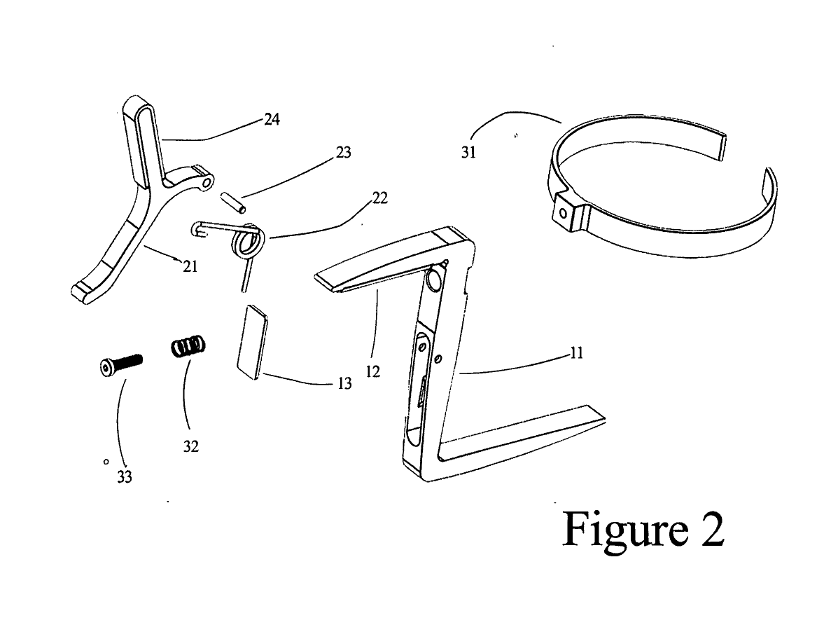

Optional pads 12, 13, and 24 are shown in FIG. 2. Their function is to prevent marring of the surfaces of the fixture and to increase the friction holding force of the clamp assembly.

### Description of Operation

In the clamp apparatus's at-rest position, lower arm segment 21a and upper arm segment 11a may be touching or apart. The at-rest distance between them is held by the undeflected position of torsion spring 22.

Grasping spine segment 11b with the thumb or palm, the user squeezes trigger segment 21b toward spine segment 11b. This pivots 21 at the fulcrum location of pin 23. This lever action deflects torsion spring 22, thereby storing mechanical energy in torsion spring 22.

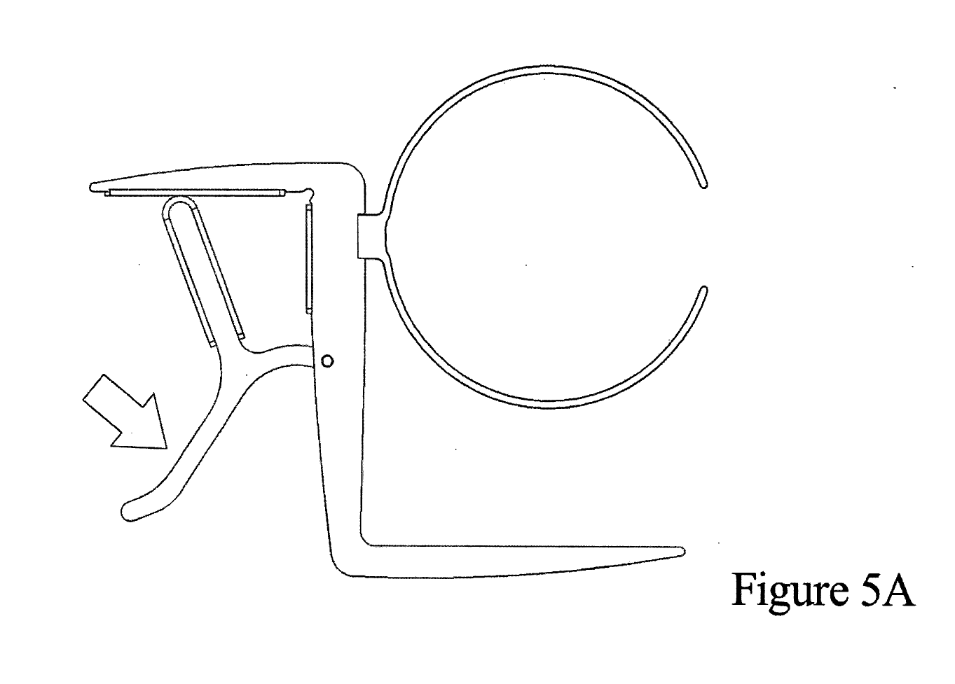

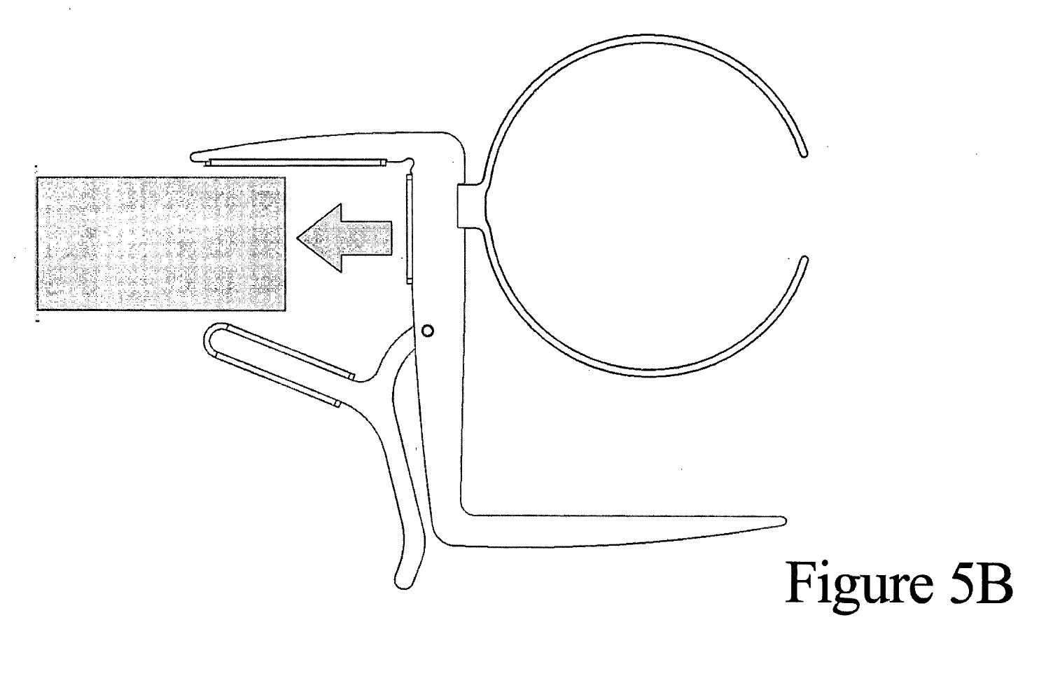

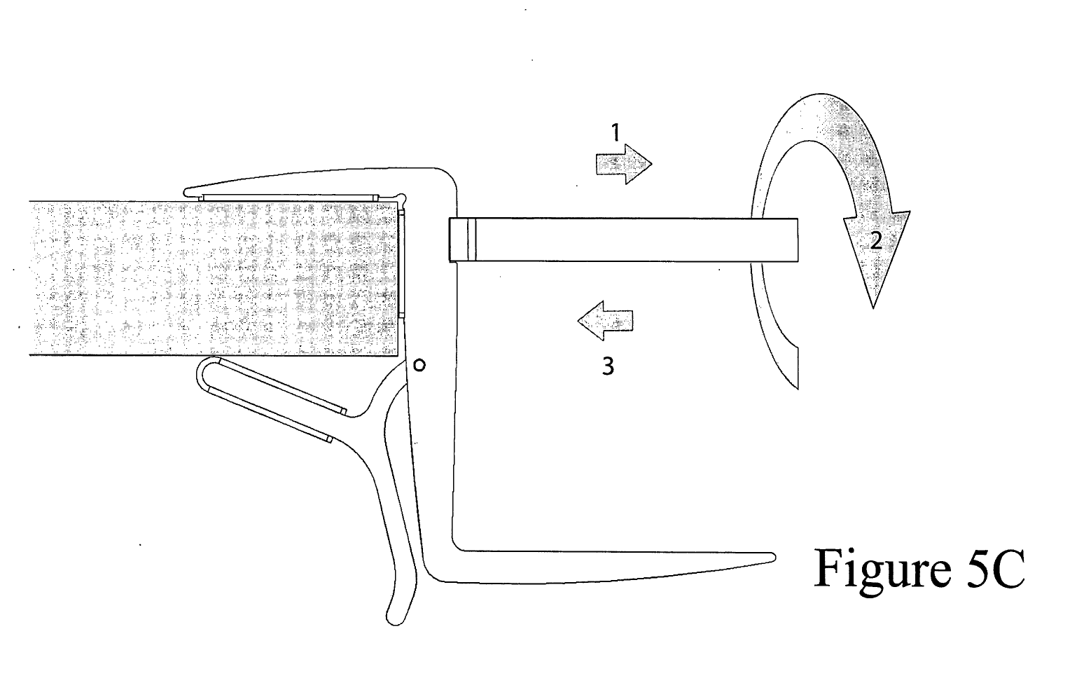

This same lever action also pulls lower arm segment 21a away from upper arm segment 11a. When lower arm segment 21a and upper arm segment 11a are apart (FIG. 5B), the user slides the device onto a fixture. Upper arm segment 11a sits flat on the surface of the fixture.

When the invention is positioned on the fixture, trigger segment 21b is released, and the energy stored in torsion spring 22 pivots lever 21 and its lower arm segment 21a back toward its resting position, that is upward toward the underside of the fixture. The mechanical energy stored in torsion spring 22 creates the holding force necessary for upper arm segment 11a and lower arm segment 21a to grip the fixture between them.

With the invention clamped onto the fixture, the user pulls ring 31 away from body 11 until the head on pin 33 prevents further distancing. This action compresses spring 32, storing mechanical energy in it. Next, the user rotates and releases ring 31. The mechanical energy stored in compression spring 32 creates the holding force necessary for ring 31 and body 11 to be held together.

If the user has rotated the ring 90 degrees, cube-shaped tenon segment 31a will sit inside square-shaped mortise segment 11d. As a result, ring 31 will not be able to turn unless it is pulled away from body 11 again.

The user can then place a cup or other container into ring 31. If the cup is shaped like an upside-down cone or an upside-down conical frustum, and the diameter of ring 31 is smaller than the cup's top diameter but larger than the cup's bottom diameter, the cup will be held laterally and vertically by the inside of ring 31.

However, if the diameter of ring 31 is larger than the container's top diameter, ring 31 will hold the cup laterally, and leg segment 11c will hold the container vertically.

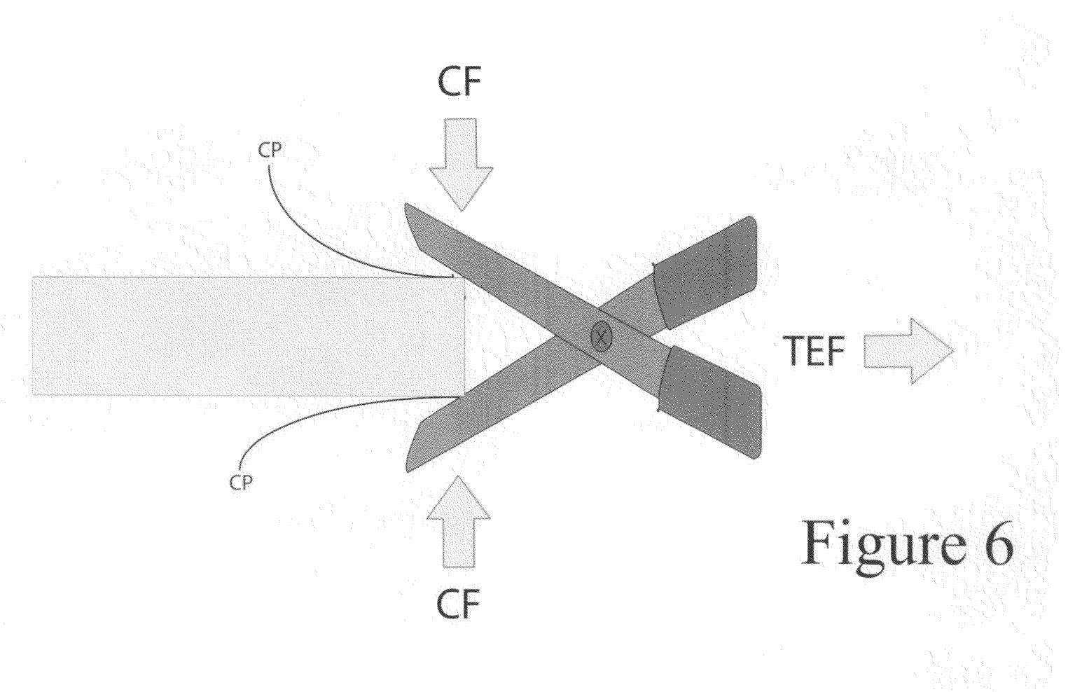

FIG. 6 shows that when a holding mechanism is a scissors-style spring clamp, the clamping contact points CP cannot be perfectly normal to both the topside and the underside of the fixture. This is so because the two clamping arms are applying clamping force CF diagonally to the surface of the fixture. In such a case, the resulting clamping force has components that simultaneously push the device into the and pull it away from the fixture via a traverse ejection force, TEF, that acts on the clamp (i.e., “side-loading”).

Scissors-style spring clamps, by their design, typically have their contact points at or near the fixture's corner edges.

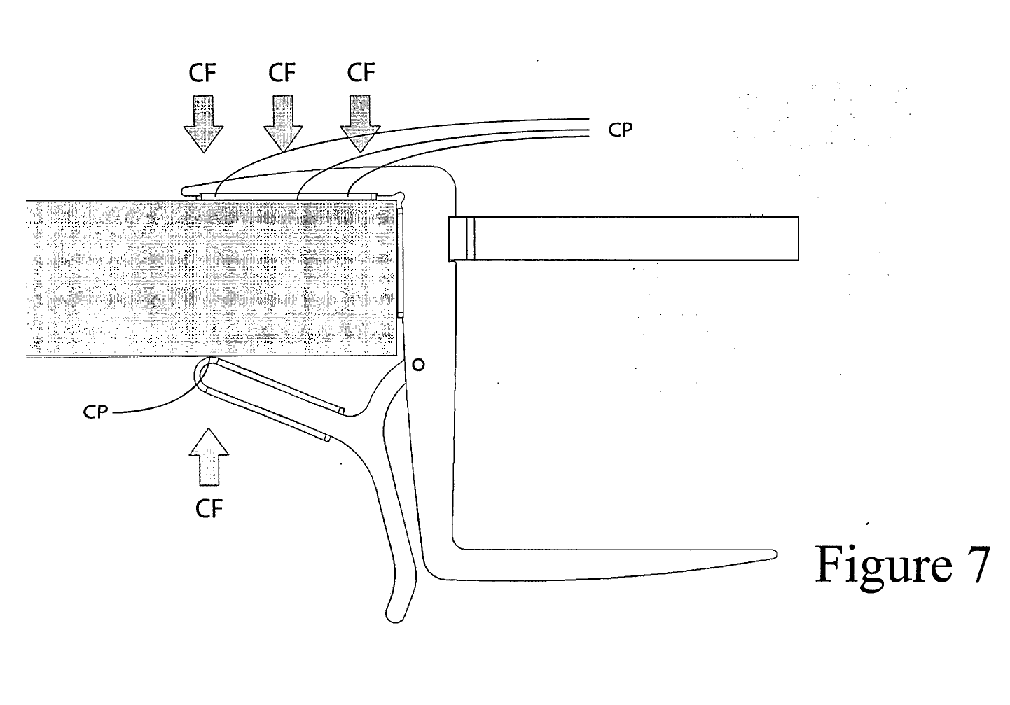

FIG. 7 shows that in my invention, the location of the underside contact point along lower arm segment 21a is always perpendicular to the fixture surface.

Another benefit of my design is that by moving contact points CP away from the corner of the fixture, the strength of the holding force is increased.

A third benefit of my design is that the contact points on the top of the fixture are spread out over a greater surface area, thereby increasing clamping force.

My design is novel in that the surface of the lower arm segment 21 is convex while the surface of the opposing upper arm segment 11a is extended and flat. As a result, the contact point CP of the lower arm segment 21a is always directly opposite a series of continuous contact points of upper arm segment 11a to the top side of the fixture. Regardless of the thickness of the fixture and the amount of open space between the opposing arms, there is an upper arm segment 11a contact point directly opposite the contact point between the underside of the fixture and the lower arm segment 21a. In my design, between the two contact points, most of the holding force is perpendicular to the surface of the fixture, and so there is no side-loading or ejection force. Without an ejection force, all of the mechanical energy stored in the deflected torsion spring 22 is used only to hold the device to the fixture.

It is understood that
the devices and methods described above are novel;

this invention is not limited to holding round containers, but can be used with many other suitable items, although modifications to the holding apparatus of the device may be required for those items; and
the invention is not limited to the embodiments and illustrations described above, and includes the full scope provided by the claims appended hereto.

1-20. (canceled)

21. A device comprising
a. a novel affixing mechanism for temporarily mounting the device at a variety of locations on a fixture (such as, but not limited to, tables, desks, chairs and doors), and
b. one or more holding elements for embracing or supporting a variety of objects (such as, but not limited to, tools, containers, measurers and illuminators),
c. in a variety of orientations,
whereby said objects are made more accessible and useful and less hazardous.

22. The affixing mechanism of claim 21 wherein opposing jaws—an upper jaw and a lower jaw—squeeze part of the fixture between them strongly enough to attach the device to the fixture.

23. The affixing mechanism of claim 22 wherein all or a significant part of the surface of the upper jaw comes into contact with and applies pressure to the fixture.

24. The affixing mechanism of claim 22 wherein a fulcrum is positioned so that it is under the fixture's surface, instead of hanging out and away from that surface.

25. The affixing ‘mechanism of claim 22 wherein the lower jaw pivots at a fulcrum point which is located lower than the most-inside location of the upper jaw.

26. The affixing mechanism of claim 22 wherein the elements through which the squeezing force is applied—the trigger/handle of the lever assembly and spine/handle segment of the body—are at an angle to the plane of the upper jaw.

27. The affixing mechanism of claim 22 wherein the handle for the lower jaw is a lever.

28. The affixing mechanism of claim 22 wherein a spring is compressed to store mechanical energy.

29. The affixing mechanism of claim 22 wherein a lever amplifies an input force to provide a greater output force, which is said to provide leverage.

30. The affixing mechanism of claim 22 wherein the output force created by the lever is stored by compressing a spring.

31. The affixing mechanism of claim 22 wherein the released force of the compressed spring is the urging means that squeezes the two jaws together.

32. The affixing mechanism of claim 22 wherein the jaws are positioned so that they each express holding forces that are perpendicular or roughly perpendicular to the plane of the surface of the fixture to which the affixing mechanism is attached.

33. The device of claim 21 wherein a variety of holding structures, fixed or interchangeable, can hold or support a variety of objects so that the objects are where the user desires to locate them and orient them.

34. The holding structure of claim 33 wherein a variety of interchangeable incorporated holding structures are the means for hanging a variety of tools, containers and other objects.

35. The holding structure of claim 33 wherein a protruding leg is the structure on which a variety of tools, containers and other objects can be supported.

36. The holding structure of claim 33 that can grasp containers such as cups with handles; cups without handles; beverage cans; bottles (including thermos bottles); and boxes.

37. The holding structure of claim 33 that is a ring that can be rotated parallel to the plane of the affixing mechanism—or detached from the device—to make the device flatter and thinner so that it is easier to store and carry.

38. The holding structure of claim 33 that can be rotated to a variety of positions relative to the affixing mechanism, including perpendicular, so that the holding apparatus may be used to embrace a variety of objects in a position to increase those objects' functionality.

39. The holding structure of claim 33 that can be replaced with a specialized holding or hanging device for such objects as tools or illuminators.

40. The holding structure of claim 33 in the shape of an open ring where the open space allows for flexibility of the ring's arms.
